(19) United States
(12) Patent Application Publication
(10) Pub. No.: US 2025/0342396 A1
(43) Pub. Date: Nov. 6, 2025

(54) DEVICE AND COMPUTER PROGRAM FOR COMPRESSING A MACHINE LEARNING MODEL WHILE PRESERVING PERFORMANCE GOALS

(71) Applicant: Aleph Alpha GmbH, Heidelberg (DE)

(72) Inventors: Björn DEISEROTH, Heidelberg (DE); Constantin EICHENBERG, Heidelberg (DE)

(21) Appl. No.: 18/899,665

(22) Filed: Sep. 27, 2024

(30) Foreign Application Priority Data
May 2, 2024 (DE) 20 2024 102 260.2

(51) Int. Cl. G06N 20/00

(52) U.S. Cl. CPC G06N 20/00

(57) ABSTRACT

A computing system is provided for evaluating performance of a compressed machine learning model. A sequence of target logits are obtained, and a sequence of compressed-model logits are calculated using the compressed machine learning model. A comparison value is determined based on the sequence of target logits and the sequence of compressed-model logits.

### CROSS-REFERENCE TO RELATED APPLICATION

This application claims priority to DE 20 2024 102 260.2 filed May 2, 2024, the entire contents of which are hereby incorporated by reference.

### TECHNICAL FIELD

The present invention relates to a device or system and computer program for evaluating the performance of a compressed machine learning model based on a comparison value, a device for evaluating the performance of a compressed machine learning model based on a predetermined number of comparison values, and a device and computer program for compressing a machine learning model.

### TECHNICAL BACKGROUND

Recent advances in the field of artificial intelligence (AI) including the rise of novel deep learning architectures such as the transformer architecture in combination with access to an ever-increasing amount of computing power have fueled the emergence of Large Language Models (LLMs). Large Language Models such as Generative Pre-Trained Transformer (GPT) 3 and GPT-4, which are part of the GPT-series, and the Large Language Model Meta AI (LLaMA) and the LLaMA-family, have transformed computational linguistics and particularly natural language processing (NLP). With their ability to process vast amounts of text and learn intricate linguistic patterns, Large Language Models can be extremely competent in various natural language processing tasks. Large Language Models further demonstrate an unprecedented proficiency in understanding and generating human-like text. This applies across a wide spectrum of topics from quantum computing to cooking recipes and across a wide spectrum of languages.

A current problem of Large Language Models is their ever-increasing size, measured for example by the number of parameters reaching magnitudes of a billion parameters and even a trillion parameters. A partial motivation behind the increase in size is the belief that larger models are able to capture more nuanced linguistic patterns and context, which leads to a higher performance and improves the capabilities of the model. It goes without saying that the immense scale of Large Language Model requires massive amounts of computational resources.

Model compression is one proposed solution for countering the ever-increasing size of Large Language Models. Model compression aims to reduce the size and complexity of the model while preserving the model's performance. Common compression principles include for example pruning redundant parameters, quantizing weights and sparsification. To further enhance model compression techniques, it is crucial to understand which techniques lead to the desired outcomes and which techniques degrade the performance of the model to an unwanted degree and should not be pursued further. This kind of understanding is preceded by accurate techniques for evaluating compressed models. Conventional methods for model evaluation include standard natural language processing benchmarks such as accuracy and perplexity (PPL), a metric designed for the evaluation of Large Language Models.

However, since these evaluation techniques are not intended to encapsulate the impact of different compression techniques on machine learning models, they come with various disadvantages. A disadvantage of conventional methods for model evaluations may be their inability to capture the diverging performance nuances that are introduced by the compression. More specifically, misalignment between the evaluated and the actual performance of the compressed model may lead to subtle discrepancies between the outputs of a base model and a compressed version of the base model. These discrepancies may often not be accurately represented in conventional techniques. The conventional techniques thus may have the disadvantage of misrepresenting the performance of a compressed model. Furthermore, such misalignment may be a severe problem, since even small divergences in tokens may lead to drastically different overall output results. Moreover, inaccurate evaluation of a compressed model's performance may have significant consequence in the development of further compression strategies. More specifically, without accurately measuring the impact of specific compression techniques, it is difficult if not impossible to improve these compression techniques. Finally, conventional metrics may suffer from a false positive (e.g., a compressed model receives the same performance score as a base model but delivers different output) or false negative (e.g., a compressed model receives a different performance score than a base model but delivers same/similar output) when evaluating compressed models.

In view of these disadvantages, the presently known evaluation techniques for compressed models may not always lead to the desired results. There is thus a need to improve the presently used evaluation techniques for compressed models such that the performance of the compressed model is accurately evaluated and machine learning models can be compressed and in such a manner that they still achieve certain performance goals.

Against this background, an object of the present invention is to address one or more or all of the above-mentioned disadvantages.

### SUMMARY OF THE INVENTION

The above-mentioned objects and other objects, which become apparent from the following description, are solved by the subject-matter of the independent claims. Preferred embodiments are subject of the dependent claims.

A 1^{st} embodiment of the invention is directed to a device or system for evaluating the performance of a compressed machine learning model based on a comparison value, the device or system comprising: means for obtaining a sequence of target logits; means for calculating, using the compressed machine learning model, a sequence of compressed-model logits; means for determining the comparison value based on the sequence of target logits and the sequence of compressed-model logits.

Means for obtaining a sequence of target logits may have the advantage of providing an accurate ground truth which may function as a baseline for evaluating the performance of the compressed machine learning model. The ground truth (e.g., the sequence of target logits) may be interpreted as the most accurate and reliable information that is available in a specific context. Moreover, obtaining the sequence of target logits may comprise a plurality of elements that make up the sequence. Accordingly, the ground truth may comprise more than one element which may increase the accuracy of the information provided by the ground truth. Another advantage of obtaining a sequence of target logits may be that the sequence, which may be described as an ordered collection of elements, itself may contain valuable information. Moreover, using logits may have the advantage of providing numerical stability in comparison to similar parameters that could be used for the performance evaluation of a compressed model.

This advantage may be specifically pronounced when handling extremely small or extremely large numbers. Another advantage of using logits may be their high level of interpretability. In other words, logits may be easier to interpret than comparable parameters. Thus, the sequence of target logits may be critical for evaluating the compressed machine learning model.

Means for calculating, using the compressed machine learning model, a sequence of compressed-model logits may have similar advantages as means for obtaining a sequence of target logits, as mentioned above. More specifically, the advantages that may be obtained from the use of logits may be the same as for the sequence of compressed-model logits. The advantages that may be related to the sequential nature of the information may also apply to the sequence of compressed-model logits, with the difference that the compressed-logits are not seen as the ground truth and thus the sequential nature may improve the accuracy of the information that is coming from the compressed model that is to be evaluated.

Means for determining the comparison value based on the sequence of target logits and the sequence of compressed-model logits may have the advantage of using logits instead of other parameters that might also be suitable for evaluation purposes, as mentioned above. Moreover, basing the determination of the comparison values on the sequence of target logits and the sequence of compressed-model logits may provide a benchmark which may facilitate standardization of results and comparison between results. Advantages stemming from the sequential nature of the compared data may be similar to the ones mentioned above (e.g., the data being more accurate and providing more inherent information).

According to a 2^{nd} embodiment, the means for determining the comparison value comprises: means for determining, as the comparison value, the first index position of the sequence of compressed-model logits, at which a logit of the sequence of compressed-model logits differs from a logit of the sequence of target logits.

Determining, as the comparison value, the first index position of the sequence of compressed-model logits, at which a logit of the sequence of compressed-model logits differs from a logit of the sequence of target logits may have the advantage of providing a discriminative comparison value. In other words, the comparison value may be able to effectively distinguish between different classes and categories. The manner in which the comparison value is determined may also result in the comparison value being sensitive to small changes of the performance of the compressed model that is being evaluated. A further advantage of means for determining the comparison value in the above-described manner may be the ease of interpretation. Moreover, means for determining the first index position as described above may save computational resources. The saving of computational resources may be due to the low complexity of the manner in which the comparison value is determined. A further advantage of the comparison value as described above is that it may be more accurate in evaluating the performance of a compressed machine learning model than conventionally used values. Moreover, an advantage of the above-described comparison value may be that it requires a limited amount of data.

According to a 3^{rd} embodiment, the means for determining the comparison value comprises: means for determining, as the comparison value, the total number of index positions at which a logit of the sequence of compressed-model logits differs from a logit of the sequence of target logits.

Means for determining, as the comparison value, the total number of index positions, at which a logit of the sequence of compressed-model logits differs from a logit of the sequence of target logits may have the advantage of being computationally efficient. This may further provide the advantage of saving computational resources. A further advantage of means for determining the comparison value in the above-described manner are ease of interpretation. A further advantage of the comparison value as described above is that it may be more accurate in evaluating the performance of a compressed machine learning model than conventionally used values. Moreover, an advantage of the above-described comparison value may be that it requires a limited amount of data.

According to a 4^{th} embodiment, the machine learning model is an auto-regressive machine learning model, preferably a large language machine learning model.

The machine learning model being an auto-regressive machine learning model may provide the advantage of generating output that is sequential in nature. Accordingly, auto-regressive machine learning models may deliver output results that are suitable for evaluation according to any one of the embodiments. The machine learning model preferably being a large language machine learning model may also provide the advantage of generating output that is sequential in nature. Large language machine learning models may also provide the advantage of being particularly suitable for the evaluation (e.g., the performance evaluation of compressed models may work well on large language models).

According to a 5^{th} embodiment, the compressed machine learning model has been compressed using means for compressing, the means for compressing being configured to apply one or more sparsification compression techniques; and/or one or more quantization compression techniques.

Compressing the machine learning model using one or more sparsification compression techniques may have the advantage of increasing interpretability of the model. This may be because sparsification may remove redundant information and may highlight relevant information. Compressing the machine learning model using one or more sparsification compression techniques may have the advantage of being easily implemented. Both compression techniques may have the advantage of being computationally efficient and thus saving computational resources. Another advantage of both compression techniques may be that the compressed model may be used in combination with hardware accelerators which may further improve speed and energy efficiency. Moreover, both compression techniques may scale easily.

According to a 6^{th} embodiment, the means for compressing are configured to apply one or more hardware accelerators during compression.

The means for compressing being configured to apply one or more hardware accelerators during compression may have the advantage of speeding up the compression process. Moreover, hardware accelerators may have the advantage of being more efficient which may reduce the computational resources required for the compression process.

According to a 7^{th} embodiment, the means for calculating the sequence of compressed-model logits are configured to calculate the sequence of compressed-model logits based on a greedy prediction algorithm.

Basing the calculation of the sequence of compressed-model logits on a greedy prediction algorithm may provide the advantage of being computationally efficient. Moreover, a greed prediction algorithm may be straight forward and simple to understand and may thus facilitate further research. A further advantage of the greedy decoding algorithm may be its low requirements with regards to memory. While more sophisticated algorithms may require large amounts of storage space, a greedy prediction algorithm may require less storage space. Note that the advantage with regards to storage may be especially beneficial due to the large size of the machine learning models. Moreover, in contrast to other algorithms, greedy decoding algorithms may be easier to interpret. Finally greedy prediction algorithms may be advantageous due to their flexibility for example with regards to customization such as the incorporation of different scoring function.

According to an 8^{th} embodiment, the means for calculating the sequence of compressed-model logits are configured to calculate the sequence of compressed-model logits in a single forward pass.

Calculating the sequence of compressed-model logits in a single forward pass may have the advantage of being computationally efficient and thus may save computational resources. Moreover, calculating the logits in a single forward pass may increase accuracy. This may be because there are no unnecessary intermediate steps that may influence the final results.

According to a 9^{th} embodiment, the means for obtaining the sequence of target logits comprises: means for calculating, using a base machine learning model, the sequence of target logits; wherein the compressed machine learning model is a compressed form of the base machine learning model.

Using a base machine learning model to calculate the sequence of target logits, wherein the compressed machine learning model is a compressed form of the base machine learning model may have the advantage of directly comparing a base model and its compressed version. This may further have the advantage of enabling evaluation of specific compression techniques.

According to a 10^{th} embodiment, the means for calculating the sequence of target logits are configured to calculate the sequence of target logits based on a greedy prediction algorithm.

Basing the calculation of the sequence of target logits on a greedy prediction algorithm may provide the advantage of being computationally efficient. Moreover, a greed prediction algorithm may be straight forward and simple to understand and may thus facilitate further research. A further advantage of the greedy decoding algorithm may be its low requirements with regards to memory. While more sophisticated algorithms may require large amounts of storage space, a greedy prediction algorithm may require less storage space. Note that the advantage with regards to storage may be especially beneficial due to the large size of the machine learning models. Moreover, in contrast to other algorithms, greedy decoding algorithms may be easier to interpret. Finally greedy prediction algorithms may be advantageous due to their flexibility for example with regards to customization such as the incorporation of different scoring function.

According to an 11^{th} embodiment, the means for calculating the sequence of target logits are configured to calculate the sequence of target logits in a single forward pass.

Calculating the sequence of target logits in a single forward pass may have the advantage of being computationally efficient and thus may save computational resources. Moreover, calculating the logits in a single forward pass may increase accuracy. This may be because there are no unnecessary intermediate steps that may influence the final results.

A 12^{th} embodiment of the invention is directed to a device or system for evaluating the performance of a compressed machine learning model based on a predetermined number of comparison values, the device or system comprising: means for obtaining the predetermined number of comparison values, wherein each of the predetermined number of comparison values is obtained using the device or system of any one the preceding embodiments; and means for evaluating, based on the predetermined number of comparison values, the performance of the compressed machine learning model.

Obtaining a predefined number of comparison values using the device of any one of the preceding embodiments may have the advantage of evaluating a compressed machine learning model on a plurality of comparison values. This may further have the advantage of an increase statistical significance of the result of the comparison. Moreover, obtaining the predefined number of comparison values using any one of the preceding embodiments may encompass the advantages discussed with regards to the respective embodiments.

According to a 13^{th} embodiment, the means for evaluating comprises: means for calculating the sum of the predetermined number of comparison values; and means for dividing the sum of the predetermined number of comparison values by the predetermined number of times to obtain an average comparison value.

Means for calculating the sum of the plurality of comparison values and means for dividing the sum of the plurality of comparison values by the predetermined number of times to obtain an average comparison value may provide the advantage of providing a concise summary of the overall performance. Moreover, the resulting average comparison value may have the advantage of being easily interpreted. A further advantage of an average comparison value may be its ease of computation which may also result in a decreased use of computational resources.

According to a 14^{th} embodiment the means for evaluating comprises: means for predetermining a percentile; and means for determining the percentile value of the predetermined number of comparison values at the predetermined percentile to obtain a percentile comparison value.

Means for predetermining a percentile and means for determining the percentile value of the predetermined number of comparison values at the predetermined percentile to obtain a percentile comparison value may have the advantage of being a robust measure of performance of the compressed model. A further advantage may be that the percentile comparison value is easy to interpret. Moreover, the percentile comparison value may be advantageous for comparison between different models. The percentile comparison value may also be computationally efficient to compute and thus may lead to a decrease in required computational resources.

A 15^{th} embodiment of the invention is directed to a device or system for compressing a base machine learning model, wherein the base machine learning model comprises or consists of one or more components, the device or system comprising: means for sparsifying the one or more components of the base machine learning model using the device or system of any one of the preceding embodiments in making the decision whether and/or to which degree the respective component is sparsified.

The advantages mentioned with regards to embodiment 1 to 14 may also apply to embodiment 15. Moreover, sparsifying the one or more components of the base machine learning model may have the advantage of applying the compression technique (e.g., sparsification) on a component level. Sparsifying on a component level may have the advantage on performing a more granular compression which may improve the results of the compression. Furthermore, performing compression on a component level may provide a higher level of control with regards to where compression takes place, which may in turn improve the results of the compression.

A 16^{th} embodiment of the invention is directed to a device or system for compressing a base machine learning model, wherein the base machine learning model comprises or consists of a plurality of components, and the plurality of components comprises a plurality of values, the device or system comprising: means for creating, for each component of the plurality of components, an evaluation set comprising a minimum sparsity performance evaluation value, a maximum sparsity performance evaluation value, and one or more, preferably two intermediate sparsity performance evaluation values, wherein a sparsity performance evaluation value expresses the performance of the base machine learning model after a respective (minimum, maximum, or intermediate) sparsity has been added to the model; means for interpolating the plurality of values of each component based on the evaluation set of that component to obtain interpolated values; and means for pruning the base machine learning model based on the interpolated values, to obtain a compressed machine learning model.

Means for creating, for each component of the plurality of components, an evaluation set may have the advantage of basing the compression technique on sub-part of the entire model. This may further have the advantage of providing an efficient compression technique that may save computational resources. Creating an evaluation set for each component may also provide the advantage of a more granular compression techniques.

The evaluation set comprising a minimum evaluation value, a maximum evaluation value, and one or more intermediate evaluation values, preferable two intermediate evaluation values may have the advantage of improving the performance of the compression technique. In other words, this feature may provide a high level of compression while maintaining the performance or not experience a significant reduction in performance. Moreover, the evaluation set may enable an assessment of how different sparsification of a specific component influence the performance of a compressed model. A minimum evaluation value and a maximum evaluation value may improve interpolation.

Means for interpolating the plurality of values of each component, based on the evaluation set of that component may have the advantage of being computationally efficient and thus saving computational resources. Interpolation may also provide a suitable tradeoff between achieving a desirable compression result and time and effort spent on computing.

Means for pruning the base machine learning model based on the interpolated values may have the advantage of providing a compressed machine learning model. Moreover, the pruning step may provide all the advantages that come with sparsifying a model such as a decrease in the computational resources that is required to save and run the model.

According to a 17^{th} embodiment, the means for creating the evaluation set are configured to calculate the one or more intermediate sparsity performance evaluation values using the device or system of any one of embodiments 1 to 14.

Calculating the one or more intermediate evaluation values using the device or system of any one of embodiments 1 to 14, may provide the advantages mentioned with regards to the embodiments 1 to 14. Moreover, calculating the one or more intermediate evaluation values using the device or system of any one of embodiments 1 to 14 may provide the advantage of calculating an evaluation value that accurately reflects the performance of the compressed machine learning model. Accordingly, calculating the one or more intermediate evaluation values in this manner may improve the results of the compression.

According to a 18^{th} embodiment, the one or more intermediate sparsity performance evaluation values are based on a target sparsity increase value.

Basing the one or more intermediate evaluation values on the target sparsity increase value may have the advantage of incorporating performance evaluations of possible sparsification into the compression. Moreover, having one or more intermediate evaluation values may provide the advantage of a more granular evaluation approach which may improve the results of the compression.

According to a 19^{th} embodiment, wherein interpolating is performed in a segment-wise manner, preferably in a segment-wise linear manner.

Interpolating in a segment-wise manner, preferably in a segment-wise linear manner may have the advantage of incorporating a component's influence on a compressed model's performance. Moreover, interpolation may be computationally efficient.

According to a 20^{th} embodiment, the device or system comprising: means for determining a sparsity value for each component configured to obtain one or more sparsity values; wherein the means for interpolating are configured to interpolate based on a weighted mean of the one or more sparsity values.

An advantage of determining a sparsity value for each component may be to provide a value for assessing the sparsity for a specific component. Moreover, constructing a weighted mean of the one or more sparsity values may have the advantage of distributing the sparsification between different components. Basing interpolation on the one or more sparsity values may enable the compression process to consider sparsification on a more abstract level, incorporating more than one component and may improve the results of the compression.

A 21^{st} embodiment of the invention is directed to a device or system for compressing a base machine learning model, the device or system comprising: means for iteratively compressing the base machine learning model using the device or system of any one of embodiments 15 to 20 and a plurality of target sparsity increase values.

Means for iteratively compressing the base machine learning model may result in a more gradual and controlled compression process. While conventional compression techniques may compress a model by 25% in one step, the above-described feature allows the model to be compressed by a total of 25% but uses several iterations for the compression. This may have the advantage of stopping compression at a beneficial moment. It could for example be the case that the best compression rate is achieved after a total compression rate of 20%. Accordingly, iteratively compressing the model may lead to better compression results.

A 22^{nd} embodiment of the invention is directed to a device or system for providing a compressed machine learning model, the device or system comprising: means for compressing a base machine learning model; means for evaluating whether the performance of the compressed base machine learning model meets predefined criteria, using the device or system of any one of embodiments 1 to 14; and means for providing the compressed base machine learning model as an output if the compressed base machine learning model meets predefined criteria.

Evaluating whether the performance of the compressed base machine learning model meets predefined criteria, using the device or system of any one of embodiments 1 to 14 may have the advantages that were mentioned with regards to embodiments 1 to 14. Moreover, means for providing the compressed base machine learning model as an output if the compressed base machine learning model meets predefined criteria may enable criteria driven compression. Thus, overcall the compression may be more tailored to a specific application scenario which may improve the results of the compression.

According to a 23^{rd} embodiment, the means for compressing are the device or system of any one of embodiments 15 to 21.

Performing compression using the device or system of any one of embodiments 15 to 22 may provide the advantages that were mentioned with regards to embodiments 15 to 22.

A 24^{th} embodiment of the invention is directed to a computer program for evaluating the performance of a compressed machine learning model based on a comparison value, the computer program comprising instructions which, when the program is executed by a computer, cause the computer to: obtain a sequence of target logits; calculate, using the compressed machine learning model, a sequence of compressed-model logits; determine the comparison value based on the sequence of target logits and the sequence of compressed-model logits.

The advantages that were discussed with regards to embodiment 1 may also apply to embodiment 24.

A 25^{th} embodiment of the invention is directed to computer program for evaluating the performance of a compressed machine learning model based on a predetermined number of comparison values, the computer program comprising instructions which, when the program is executed by a computer, cause the computer to: obtain the predetermined number of comparison values, wherein each of the predetermined number of comparison values is obtained using the device or system of any one embodiments 1 to 11; and evaluate, based on the predetermined number of comparison values, the performance of the compressed machine learning model.

The advantages that were discussed with regards to embodiments 1 to 12 may also apply to embodiment 29.

A 26^{th} embodiment of the invention is directed to a computer program for compressing a base machine learning model, wherein the base machine learning model comprises one or more components, the computer program comprising instructions which, when the program is executed by a computer, cause the computer to: sparsify the one or more components of the base machine learning model using the device or system of any one of the embodiments 1 to 14.

The advantages that were discussed with regards to embodiments 1 to 15 may also apply to embodiment 26.

A 27^{th} embodiment of the invention is directed to a computer program for compressing a base machine learning model, wherein the base machine learning model comprises or consists of a plurality of components, and the plurality of components comprises a plurality of values, the computer program comprising instructions which, when the program is executed by a computer, cause the computer to: create for each component of the plurality of components, an evaluation set comprising a minimum sparsity performance evaluation value, a maximum sparsity performance evaluation value, and one or more, preferably two intermediate sparsity performance evaluation values, wherein a sparsity performance evaluation value expresses the performance of the base machine learning model after a respective (minimum, maximum, or intermediate) sparsity has been added to the model; interpolate the plurality of values of each component based on the evaluation set of that component to obtain interpolated values; and prune the base machine learning model based on the interpolated values, to obtain a compressed machine learning model.

The advantages that were discussed with regards to embodiment 16 may also apply to embodiment 27.

A 28^{th} embodiment of the invention is directed to a computer program for compressing a base machine learning model, the computer program comprising instructions which, when the program is executed by a computer, cause the computer to: iteratively compress the base machine learning model using the device or system of any one of embodiments 15 to 20 and a plurality of target sparsity increase values.

The advantages that were discussed with regards to embodiments 15 to 21 may also apply to embodiment 28.

A 29^{th} embodiment of the invention is directed to a computer program for providing a compressed machine learning model, the computer program comprising instructions which, when the program is executed by a computer, cause the computer to: compress a base machine learning model; evaluate whether the performance of the compressed base machine learning model meets predefined criteria, using the device or system of any one of embodiments 1 to 14; and provide the compressed base machine learning model as an output if the compressed base machine learning model meets predefined criteria.

The advantages that were discussed with regards to embodiments 1 to 14 and 22 may also apply to embodiment 29.

### BRIEF DESCRIPTION OF THE FIGURES

Various aspects of the present invention are described in more detail in the following by reference to the accompanying figures without the present invention being limited to the embodiments of these figures.

FIG. 1 illustrates an exemplary performance evaluation according to an embodiment of the present invention;

FIG. 2 illustrates an exemplary algorithm for compressing a machine learning model according to an embodiment of the present invention;

FIG. 3 illustrates sparsification as a compression technique according to an embodiment of the present invention;

FIG. 4 further illustrates sparsification as a compression technique according to an embodiment of the present invention;

FIG. 5 illustrates quantization as a compression technique according to an embodiment of the present invention;

FIG. 6 further illustrates quantization as a compression technique according to an embodiment of the present invention; and

FIG. 7 shows an example computing device that may be used in some embodiments to implement features described herein.

### DETAILED DESCRIPTION

In the following, the invention is described with reference to the accompanying figures in more detail. However, the present invention can also be used in other embodiments not explicitly disclosed hereafter. As detailed below, the embodiments are compatible with each other, and individual features of one embodiment may also be applied to another embodiment.

Throughout the figures and description, the same reference numerals refer to the same elements, unless stated otherwise. The figures do not limit the scope of the claims but merely support the understanding of the invention.

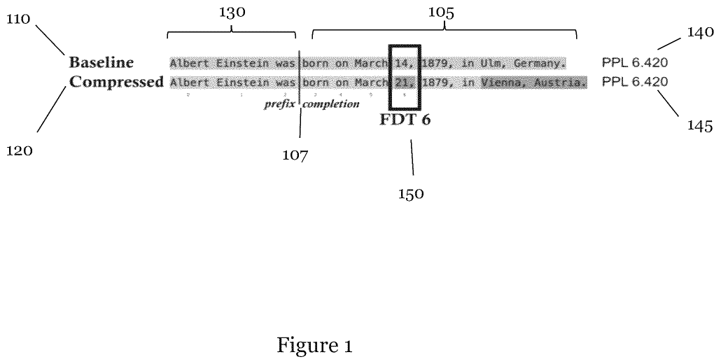

FIG. 1 shows an exemplary comparison between the outputs 105 of a base machine learning model 110 and a compressed version of the base machine learning model 120. The upper part of FIG. 1 refers to the base machine learning model 110, and the lower part of FIG. 1 refers to the compressed machine learning model 120. More specifically, FIG. 1 shows that the sentence “Albert Einstein was” was used as a prefix 130, or differently put, as an input to the machine learning model 110, 120, with the task to complete the given prefix 130 (e.g., the given sentence). To highlight the difference between the prefix 130 and the generated text 105, a straight line 107 is drawn between the last word of the prefix (e.g., “was”) and the first word (e.g., born”) of the text 105 that is actually generated by the machine learning model 110, 120. An exemplary scenario represented in FIG. 1 would be a user typing in the prefix “Albert Einstein was” and the model returning “born on Mar. 14, 1879, in Ulm, Germany.” in case of the base machine learning model 110 and “born on Mar. 21, 1879 in Vienna, Austria.” in case of the compressed machine learning model 120.

With regards to evaluating the performance of the compressed model 120, FIG. 1 shows the calculated base perplexity score 140 for the base machine learning model 110 and the calculated compressed perplexity score 145 for the compressed machine learning model 120. It is obvious that the perplexity score of the base model 140 is the same as the perplexity score for the compressed model 145, namely 6.420, even though the compressed model 130 delivered vastly different results from the base model 110. This illustrates the problem of using conventional techniques such as perplexity to evaluate the performance of a compressed model 120.

In addition to the perplexity score that is shown at the end of the generated text, FIG. 1 also highlights the first divergent token (FDT) metric 150. The first divergent token metric indicates the first index position at which the text that is generated by the base line model 110 differs from the text that is generated by the compressed model 120. In the case illustrated in FIG. 1, such difference first occurs at position 6 as calculated from the beginning of the sentence. In contrast to the perplexity metric, the first divergent token metric may have the advantage of accurately quantifying the performance difference between the base model 110 and the compressed model 120. In contrast to the perplexity metric, the first divergent token metric may at least be able to indicate that there is a performance difference between the base model 110 and the compressed model 120.

Moreover, the first divergent token metric may be interpreted as the first index position at which the text that is generated by the base model differs from the text that is generated by the compressed version of the base model. In a broader context, the first divergent token metric may be interpreted as the first index position at which a text differs from a text that is generated by a compressed model.

The first divergent token may mathematically be described as follows, wherein FDT( ) represents the first divergent token function, F represents an auto-regressive model, y=(y₁, . . . , y_{N}) ∈ V^{N} represents an arbitrary token sequence, V={0, 1, . . . , |V|−1} represents a vocabulary. Moreover, given a prefix length n<N, y_{:n}=(y₁, . . . , yₙ) represents a token prefix and F(y)=F(y)ᵢⱼ ∈ [symbol] ^{N×|V|} represent the model's logits with i denoting the sequence and j denoting the vocabulary position:

$$F D T ( y , F , n ) = min \{ i \geq n : {argmax}_{j} {F ( y )}_{i , j} \neq {y}_{i + 1} \} - n$$

A further metric, not shown in FIG. 1 is based on the share of divergent token (SDT), which may be defined as the number of times the compressed model would need to be corrected to match the base model. In a broader context, the share of divergent token may be interpreted as the number of tokens that are different between a given text and a text that is generated by a compressed model.

The share of divergent token may mathematically be described as follows, wherein the same notation as mentioned above with regards to the first divergent token holds with the difference that the function SDT( ) is used:

$$S D T ( y , F , n ) = \vert \{ i \geq n : {argmax}_{j} {F ( y )}_{i , j} \neq {y}_{i + 1} \} \vert$$

The y in either first divergent token and or share of divergent token may be replaced with a function G that may represent a decoding algorithm that takes as input parameters a model F that performs the decoding, a prefix y_{:n} that is given to the model as an input parameter and a total number of text that should be generated by the model which is denoted as N as follows. Accordingly, the first divergent token metric and the share of divergent token metric between models F and F′ are as follows:

$${M}_{FDT} ( F , {F}^{′} , {y}_{: n} , N ) = F D T ( G ( F , {y}_{: n} , N ) , {F}^{′} , n )$$

$${M}_{SDT} ( F , {F}^{′} , {y}_{: n} , N ) = S D T ( G ( F , {y}_{: n} , N ) , {F}^{′} , n )$$

The greedy decoding algorithm may provide the advantage of being computationally efficient. Moreover, in contrast to other algorithms, greedy decoding algorithms may be easier to interpret. Note also that F may represent a base machine learning model and F′ may represent a compressed version of the base machine learning model. An aggregated version of the above-mentioned metric can be calculated as follows, wherein D represents a test dataset containing documents of potentially varying lengths.

$${ℳ}_{FDT} ( F , {F}^{′} , {y}_{: n} , N ) = \frac{1}{\vert D \vert} {\sum }_{y ∈ D} {M}_{FDT} ( F , {F}^{′} , {y}_{: n} , N )$$

$${ℳ}_{SDT} ( F , {F}^{′} , {y}_{: n} , N ) = \frac{1}{\vert D \vert} {\sum }_{y ∈ D} {M}_{SDT} ( F , {F}^{′} , {y}_{: n} , N )$$

As the first divergent token metric may present the first index position at which a generated text from the base model differs from a generated text from the compressed version of the base model, it may be more desirable (e.g., have a higher performance) if the first divergent token metric has a higher score, meaning that the two models only differ at a later point in time. This information may be especially meaningful since the generated text at position x influences the text that is generated at position x+1. Accordingly, an error that occurs early on in the generated text may negatively influence the remaining text generation process. Consequently, the first divergent token metric may have the advantage of accurately quantifying the performance of a compressed model. One reason for such accurate quantification may be, as discussed above, the ability to capture early errors which may be underscored by their influence on future text generation.

In contrast to conventional evaluation techniques, the introduced evaluation techniques for compressed models such as the divergent token metric may have the advantage of being more discriminative. In other words, the introduced metrics may be able to better detect subtle changes in the performance of the model. For example, when comparing the performance of a base model to that of a compressed version of the base model, the difference in the generated text might be subtle (e.g., a paragraph consisting of 50 words might merely differ in a total of 3 tokens and the first different token might only occur at position 44). While such subtle differences may lead a conventional performance metrics to give the same performance score to the base model and to the compressed version of the base model, the newly introduced performances metrices may be able to quantify even such minor performance changes.

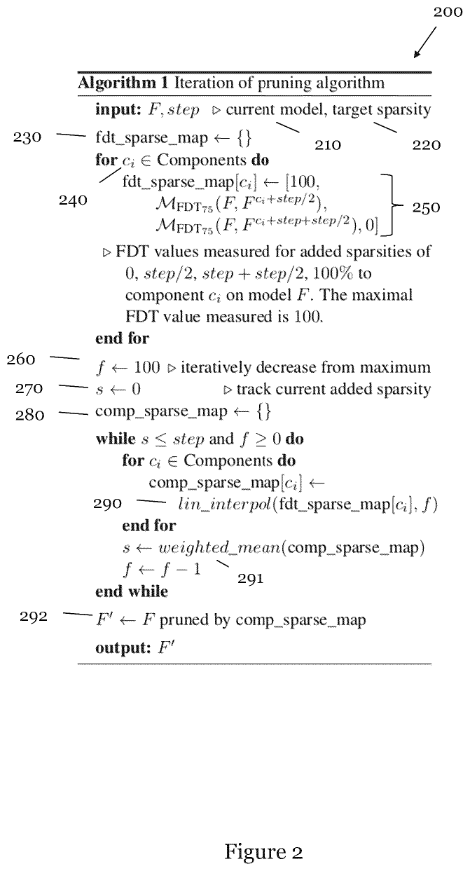

FIG. 2 shows an exemplary pseudo-code for a compression algorithm 200 that is based on sparsification (e.g., reducing the amount of information contained in the model) and uses the first divergent token metric to iteratively evaluate the performance of the compressed model. The compression algorithm 200 may be implemented as a computer program that is stored in non-transitory memory and/or executed by a hardware processor of, for example, computing system 700.

The algorithm may take as an input a current model that may be saved in the variable F 210 and a desired increase in sparsity that may be saved in the variable step 220, for example 10%.

The variable fdt_sparse_map 230 may be initialized and may serve as a data structure that may save the evaluation sets for each component of the machine learning model. A component of the machine learning model may be a matrix.

A control structure such as a for-loop may be used to iterate over each component cᵢ ∈ Components 240 of the machine learning model. During each iteration, an evaluation set 250 may be calculated for the respective component.

The evaluation set may comprise or consist of a performance evaluation for maximum sparsity, a first intermediate performance evaluation value, such as performance for a sparsity of (step/2), a second intermediate performance evaluation value, such as performance for a sparsity of (step+step/2), and a performance evaluation for minimum sparsity. The maximum performance value can be set to 100, and will be reached by the model with the uncompressed component (e.g., a compression with minimum sparsity where minimum sparsity=0%). The minimum performance value can be o, and will be reached by the model with the maximally compressed component. Note that the variable step may contain the desired increase in sparsity such as 5% In the example where step=10%, (step/2) would be 5%, and (step+step/2) would be 15%. The main idea of the evaluation set is to amend the sparsity of a component cᵢ by a certain degree (e.g., maximum sparsity, (step/2), (step+step/2), minimum sparsity) and evaluate the performance of the resulting model.

Once each element of the evaluation set has been calculated for each component of the machine learning model, the iteration in the for-loop control structure may come to an end. This may be followed by the initialization of three further variables f 260, which represents the maximal achievable first divergent token score, s 270, which keeps track of the sparsity that is currently added and comp_sparse_map 280, which represents the current sparsity values to be added to each component to achieve s at first divergent token score f.

This initialization may be followed by a second control structure such as a while loop. The while loop may operate under the condition that the current added sparsity is below or at the target sparsity s≤step and that a maximum number of iterations (e.g., maximal achievable first divergent token score) has not yet been reached f≥0. The while loop may contain a further control structure such as a for-loop. The for-loop may be used to iterate over each component cᵢ. Each iteration may be used to perform a linear interpolation, using the function lin_interpol( ) 290, based on fdt_sparse_map[cᵢ] and f and save the result in comp_sparse_map, which resembles the maximum sparsity value of component cᵢ to still achieve the first divergent token score f. The linear interpolation may be performed in a segment-wise manner. The linear interpolation may alternatively or additionally be performed in a linear manner. After each for-loop, the variable f is decreased by 1 and the variable s is updated using the function weighted_mean( ) 293 with the variable comp_sparse_map as an input (e.g., with the current weighted mean of the comp_sparse_map variable). The weighted mean may have the advantage of taking into account the sparsity of all components and not just of a single component, to distribute the error of the sparsification process among the components. In this manner, the variable comp_sparse_map is iteratively filled.

In this manner, the model F that was provided as an input is pruned, in other words, reduced in size and information, using comp_sparse_map to obtain the compressed model F′.

In summary, the algorithm may take as an input a current model F and a target increase in sparsity step and may create as an output a compressed model F′ 292. Note that this algorithm may be used in an iterative manner; for example, a target sparsity may be slowly increased to compress the model further and further. Note that the algorithm makes use of the first divergent token metric to evaluate the performance of a compressed model. This may be advantageous since the first divergent token metric, in contrast to conventional methods, is able to accurately measure the performance of a compressed machine learning model.

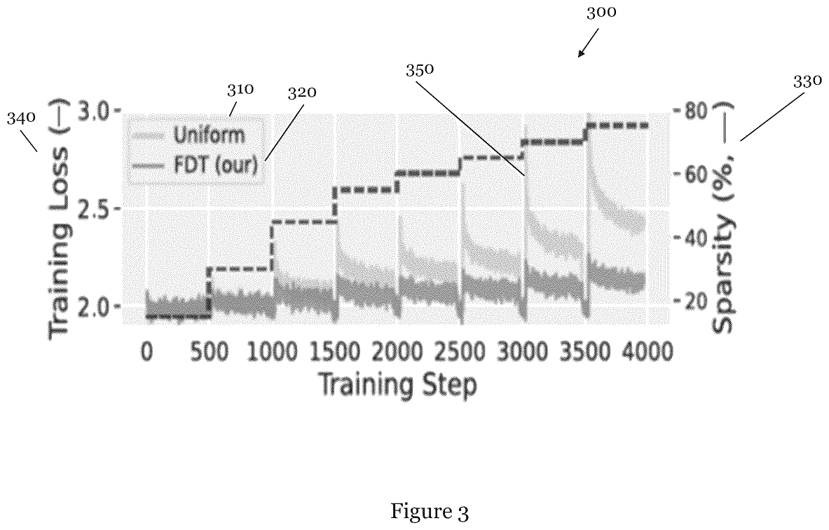

FIG. 3 compares two compression techniques, namely uniform sparsification 310 and the sparsification algorithm 320 described above that uses the first divergent token metric. The graph 300 shows the results of a specific experiment in which the average sparsity of the model was increased 8 times, which resulted in the following increases: 20% increase, 15% increase, 10% increase, 10% increase, 5% increase, 5% increase, 5% increase and a final 5% increase. These increases are represented by the dotted line in the graph 330. Note that between iterations, a certain amount of continued training steps may be executed to remove some of the introduced errors.

With reference to the first divergent token sparsification algorithm that was introduced in FIG. 2, one increase may be interpreted as performing the algorithm once, e.g., inputting F as the current model and 20% as the sparsity target increase value, and receiving F′ as the compressed model as a result. Accordingly, to achieve 8 increases, the algorithm may be iteratively performed, meaning that the compressed model F′ becomes the new current model F, and the sparsity increase value is changed from 20% to 15%. As described above, the first divergent token algorithm may determine individual component sparsification values to achieve the desired target sparsity, advantageously using the metrices according to the present invention. In contrast, the uniform sparsification algorithm applies the target increase of the current round (e.g., 20% in the first round, 15% in the second round) uniformly to each component of the machine learning model.

The graph 300 of FIG. 3 shows the training loss 340 and the sparsity 330 of the models that are trained using the uniform algorithm 310 and the first divergent token algorithm 320. It can be seen that the training loss spikes 350 for both algorithms right after a new iteration has been started (e.g., a new increase of target sparsity has taken place). While an increase in sparsity leads to an increase in training loss for both algorithms, it can be seen that the loss is significantly higher for the uniform algorithm when compared to the first divergent token algorithm. The graph 300 of FIG. 3, thus, shows that an advantage of the first divergent token metric and the respective compression algorithm may be outperforming of conventional compression algorithm. In other words, an advantage may be reducing the model in size while maintaining or at least not significantly reducing performance of the model.

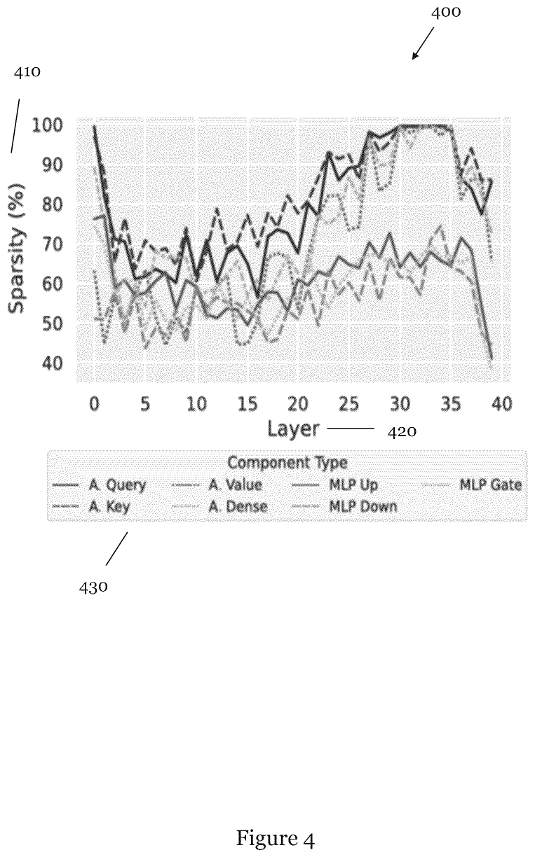

FIG. 4 provides an exemplary illustration of the sparsification (e.g., compression) at a more detailed level. More specifically, the lines that are depicted in graph 400 of FIG. 4 represent the sparsity ranging from 0% to 100% 410 of different component types of a machine learning model. In some examples, a component may be part of a machine learning model that performs a specific function and contributes to the overall performance of the model. Examples of different component types that may be included in a machine learning model include, for example, 1) A. Query; 2) A. Key; 3) A. Value; 4) A. Dense; 5) MLP (multi-layer perceptron) Up; 6) MLP Down; and 7) MLP Gate. The illustration in FIG. 4 shows example component types 430, and how the sparsity changes per layer (420) of the example mode. Each component type is represented in each layer. It can, for example, be seen that the MLP Up component type has a sparsity of around 78% in the o^{th} layer of the machine learning model. From there on, the sparsity of the MLP Up component type decreases at each layer of the model (e.g., around 60% at around layer 4, and around 50% at around layer 15), the sparsity for the MLP Up component type rises again just to end at a level of 40% at around layer 38.

The first divergent token algorithm that was further described with reference to FIG. 2 described the iterative adaption (e.g., sparsification) of the components of the model to achieve a desired target sparsity. The graph 400 that is shown in FIG. 4 aims at illustrating the sparsification on a component level. Accordingly, one advantage of the first divergent token algorithm may be that it distributes sparsification over various components to improve overall compression results. In contrast, conventional approaches such as the uniform sparsification merely apply the same amount of sparsification to each component. Thus, a further advantage of the first divergent token algorithm may be that it identifies operates on a more granular level which may improve compression.

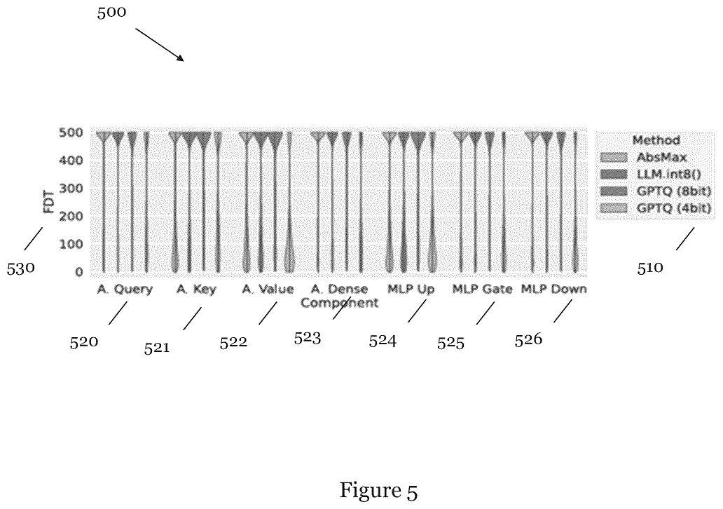

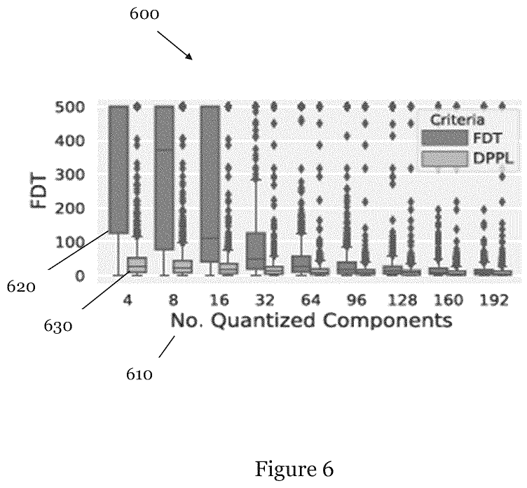

FIG. 5 and FIG. 6 illustrates how the introduced performance metrics, specifically first divergent token metric, may be used in combination with quantization. Quantization may be described as a further type of compression technique for machine learning models that reduces the precision of the numerical representations that define the machine learning model. As in every compression technique, the aim in quantization is to reduce the size of the model while maintaining the performance or minimally reducing performance.

FIG. 5 shows the performance of various quantization methods 510, namely AbsMax, LLM.int8( ) GPTQ (8 bit) and GPTQ (4 bit) on different components of the machine learning model such as A. Query 520, A. Key 521 and MLP Gate 525 as evaluated using the first divergent token performance metric 530. Since the first divergent token metric may indicate the first index position at which the text that is generated by the base model and the text that is generated by the compressed version of the base model differ, a higher first divergent token metric may be an indicator of a higher performance. FIG. 5 can be interpreted accordingly. In other words, all quantification methods seem to perform well on the A. Query component. However, there a mixed results at the MLP Up and the A. Value component. Moreover, the GPTQ (4 bit) quantizer seems to be performing worse than the AbsMax, LLM.int8( ) and GPTQ (8 bit) quantizer when measured on the first divergent token metrics. A further advantage of the introduced metrices may be their simple interpretation of complex model performance behavior. Such ease in interpretation may subsequently incentivize further model performance related research. In summary, FIG. 5 demonstrates the use of the first divergent token performance metric to evaluate different quantization strategies.

Based on the results that are shown in FIG. 5, the highest performing components (e.g., the components that minimally reduced the model's performance while allowing for compression and thus a reduction in size of the model), were identified and merged. The result is illustrated in FIG. 6.

More specifically, FIG. 6 is illustrated as a boxplot diagram 600 and shows the number of quantized components as 4, 8, 15, 32, 64 etc. 610 as the boxplot categories. Each category consists of two boxplots 620, 630, one that is showing the results for the first divergent token metric 620 and a further boxplot that is showing the results for the divergent perplexity metric 630 as a selection criteria for the best performing component. While the results for the divergent perplexity metric 630 show rather little variation between the different boxplot categories (e.g., number of quantized components), the first divergent token metric 620 demonstrates a clear difference in performance. For example, when examining the trajectory of the boxplot diagram from a minimum of four quantized components to a maximum of 192 quantized components, it can be seen that the first divergent token metric first indicates a rather high score and that the score gradually decreases the more quantized components are added to the model. Note that a high score indicates a good performance (e.g., the first divergent token occurred later in the generated text). In contrast, the divergent perplexity score does not show a large difference for the entire boxplot diagram. Moreover, the boxplot descriptor values for the measured first divergent token value are seen to be constantly and significantly higher when using first divergent token as a selection criterion, which indicates a more performant compressed model. In particular, when selecting only 4 components, the 75%-quartile is at a measured 500 for first divergent token, and around 50 for divergent perplexity.

Thus, FIG. 6 highlights that the first divergent token performance metric may have the advantage of being more discriminative than conventional methods and may be better able to indicate even small differences in performance. Another advantage that is demonstrated in FIG. 6 is the introduced performance metrics and specifically the first divergent token metric may be used to identify relevant components for quantization. This may provide an advantage over conventional methods which may not be able to discern the performance difference between a base model and the compressed model and thus may not be suitable for further investigations with regards to improving compression techniques.

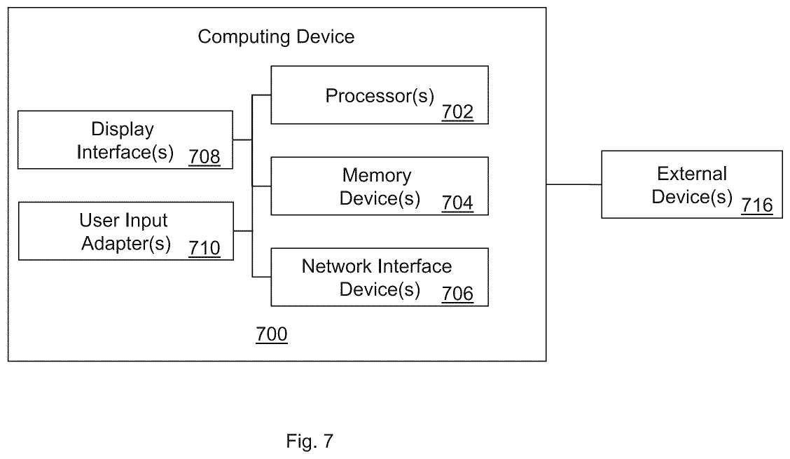

FIG. 7 is a block diagram of an example computing device 700 (which may also be referred to, for example, as a “computing device,” “computer system,” or “computing system”) according to some embodiments.

In some embodiments, the computing device 700 includes one or more of the following: one or more processors 702 (which may be referred to as “hardware processors” or individually as a “hardware processor”); one or more memory devices 704; one or more network interface devices 706; one or more display interfaces 708; and one or more user input adapters 710. Additionally, in some embodiments, the computing device 700 is connected to or includes a display device, input devices, etc. These elements (e.g., the processors 702, memory devices 704, network interface devices 706, display interfaces 708, user input adapters 710) are hardware devices (for example, electronic circuits or combinations of circuits) that are configured to perform various different functions for the computing device 700. In some embodiments, these components of the computing device 700 may be collectively referred to as computing resources (e.g., resources that are used to carry out execution of instructions and include the processors (one or more processors 702), storage (one or more memory devices 704), and I/O (network interface devices 706, one or more display interfaces 708, and one or more user input adapters 710).

In some instances, the term processing resources may be used interchangeably with the term computing resources. In some embodiments, multiple instances of computing device 700 may arranged into a distributed computing system. Computing device 700 may be configured to communicate with one or more external devices 716. External devices 716 can be other instances of computing device or may be different (e.g., just storage devices, sensors, etc.). In some examples, computing device 700 includes multiple computing devices 700. As an example, a computing device 700 includes different architectures that may be used in cloud computing environments.

In some embodiments, each or any of the processors 702 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 702 uses an instruction set architecture such as x86 or Advanced RISC Machine (ARM).

In some embodiments, each or any of the memory devices 704 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 702). Memory devices 704 are examples of non-transitory computer-readable storage media.

In some embodiments, each or any of the network interface devices 706 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), LTE Pro, Fifth Generation New Radio (5G NR) and/or other short-range, mid-range, and/or long-range wireless communications technologies).

Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an”, and “the” should be read as meaning “at least one,” “one or more,” or the like; the term “example”, which may be used interchangeably with the term embodiment, is used to provide examples of the subject matter under discussion, not an exhaustive or limiting list thereof; the terms “comprise” and “include” (and other conjugations and other variations thereof) specify the presence of the associated listed elements but do not preclude the presence or addition of one or more other elements; and if an element is described as “optional,” such description should not be understood to indicate that other elements, not so described, are required.

As used herein, the term “non-transitory computer-readable storage medium” includes a register, a cache memory, a ROM, a semiconductor memory device (such as D-RAM, S-RAM, or other RAM), a magnetic medium such as a flash memory, a hard disk, a magneto-optical medium, an optical medium such as a CD-ROM, a DVD, or Blu-Ray Disc, or other types of volatile or non-volatile storage devices for non-transitory electronic data storage. The term “non-transitory computer-readable storage medium” does not include a transitory, propagating electromagnetic signal. Computer programs described herein may be stored on a non-transitory computer-readable storage medium.

The claims are not intended to invoke means-plus-function construction/interpretation unless they expressly use the phrase “means for” or “step for.” Claim elements intended to be construed/interpreted as means-plus-function language, if any, will expressly manifest that intention by reciting the phrase “means for” or “step for”; the foregoing applies to claim elements in all types of claims (method claims, apparatus claims, or claims of other types) and, for the avoidance of doubt, also applies to claim elements that are nested within method claims. Consistent with the preceding sentence, no claim element (in any claim of any type) should be construed/interpreted using means plus function construction/interpretation unless the claim element is expressly recited using the phrase “means for” or “step for.”

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

### LIST OF REFERENCE SIGNS

105 output, generated text
107 separation between prefix and generated text
110 base machine learning model
120 compressed machine learning model
130 prefix
140 perplexity score of base model
145 perplexity score of compressed model
150 first divergent token metric
200 compression algorithm
210 current model
220 target sparsity increase
230 fdt_sparse_map
240 component of the machine learning model
250 evaluation set
260 counter f
270 current level of added sparsity
280 comp_sparse_map
290 interpolation function
291 weighted mean function
292 compressed model
300 training loss graph
310 uniform compression algorithm
320 first divergent token compression algorithm
330 sparsity scale
340 training loss scale
350 training loss spike
400 sparsity graph
410 sparsity scale
420 model layer
430 component type
500 quantization graph
510 quantization methods
520, 521, 522, 523, 524, 525, 526 model component types
530 first divergent token performance metric
600 quantization boxplot diagram
610 quantized components
620 first divergent token metric
630 divergent perplexity metric

1. A computing system for evaluating performance of a compressed machine learning model based on a comparison value, the computing system comprising:
a memory coupled to at least one hardware processor that is configured to perform operations comprising:
obtaining a sequence of target logits;
calculating, using the compressed machine learning model, a sequence of compressed-model logits; and
determining the comparison value based on the sequence of target logits and the sequence of compressed-model logits.

2. The computing system of claim 1, wherein determining the comparison value further comprises:
determining, as the comparison value, a first index position of the sequence of compressed-model logits, at which a logit of the sequence of compressed-model logits differs from a logit of the sequence of target logits.

3. The computing system of claim 1, wherein determining the comparison value further comprises:
determining, as the comparison value, a total number of index positions at which a logit of the sequence of compressed-model logits differs from a logit of the sequence of target logits.

4. The computing system of claim 1, wherein the machine learning model is an auto-regressive machine learning model or a large language machine learning model.

5. The computing system of claim 1, wherein the operations further comprise compressing a machine learning model to obtain the compressed machine learning model, wherein the compressing includes applying one or more sparsification compression techniques, and/or one or more quantization compression techniques.

6. The computing system of claim 5, wherein the compressing includes applying one or more hardware accelerators during compression.

7. The computing system of claim 1, wherein the sequence of compressed-model logits are calculated using a greedy prediction algorithm and/or a single forward pass.

8. The computing system of claim 1, wherein the compressed machine learning model is a compressed form of the base machine learning model,
wherein the operations further comprise:
calculating, using the base machine learning model, the sequence of target logits.

9. The computing system of claim 1, wherein the operations further comprise:
obtaining a predetermined number of comparison values; and
evaluating, based on the predetermined number of comparison values, performance of the compressed machine learning model.

10. The computing system of claim 9, wherein the operations further comprise:
calculating an average comparison value that is based on a sum of the predetermined number of comparison values; and
wherein the evaluating of the performance is further based on an obtained average comparison value.

11. The computing system of claim 10, wherein the operations further comprise:
predetermining a percentile; and
determining a percentile value of the predetermined number of comparison values at the predetermined percentile to obtain a percentile comparison value.

12. A computing system of claim 1, wherein the operations further comprise:
obtain a base machine learning model that includes a plurality of different components that are each one of a plurality of different component types, the computing system comprising:
sparsifying at least one or more components of the plurality of components included in the base machine learning model.

13. A computing system for compressing a base machine learning model, computing system comprising:
a memory configured to store the base machine learning model, which includes a plurality of components that comprise a plurality of values, the computing system;
at least one hardware processor coupled to the memory, the at least one hardware processor configured to perform operations comprising:
creating, for each component of the plurality of components, an evaluation set comprising a minimum sparsity performance evaluation value, a maximum sparsity performance evaluation value, and one or more, preferably two intermediate sparsity performance evaluation values, wherein a sparsity performance evaluation value expresses the performance of the base machine learning model after a respective (minimum, maximum, or intermediate) sparsity has been added to the model;
interpolating the plurality of values of each component based on the evaluation set of that component to obtain interpolated values; and
pruning the base machine learning model based on the interpolated values, to obtain a compressed machine learning model.

14. The computing system of claim 13, wherein the operations further comprise,
(a) obtaining a sequence of target logits;
(b) calculating, using the compressed machine learning model, a sequence of compressed-model logits; and
(c) determining a comparison value based on the sequence of target logits and the sequence of compressed-model logits,
wherein calculation of the one or more intermediate sparsity performance evaluation values is further based on performing (a)-(c).

15. The computing system of claim 13, wherein the one or more intermediate sparsity performance evaluation values are based on a target sparsity increase value.

16. The computing system of claim 13, wherein the operations further comprise:
obtaining one or more sparsity values by determining a sparsity value for each of the plurality of components,
wherein the plurality of values are interpolated based on a weighted mean of the one or more sparsity values.

17. A method of evaluating performance of a compressed machine learning model based on a comparison value, the method comprising:
obtaining a sequence of target logits;
calculating, using the compressed machine learning model, a sequence of compressed-model logits; and
determining the comparison value based on the sequence of target logits and the sequence of compressed-model logits.

18. The method of claim 17, further comprising:
obtaining a base machine learning model, wherein the base machine learning model includes a plurality of components, which comprises a plurality of values;
creating for each component of the plurality of components, an evaluation set comprising a minimum sparsity performance evaluation value, a maximum sparsity performance evaluation value, and one or more, preferably two intermediate sparsity performance evaluation values, wherein a sparsity performance evaluation value expresses the performance of the base machine learning model after a respective (minimum, maximum, or intermediate) sparsity has been added to the model;
interpolating the plurality of values of each component based on the evaluation set of that component to obtain interpolated values; and
generating the compressed machine learning model from the base machine learning model by pruning the base machine learning model using the interpolated values.

19. The method of claim 17, further comprising:
evaluating performance of a compressed machine learning model based on a predetermined number of comparison values; and
evaluating, based on the predetermined number of comparison values, the performance of the compressed machine learning model.

20. The method of claim 17, further comprising:
compressing a base machine learning model;
evaluating whether performance of the base machine learning model that has been compressed meets a predefined criteria, using the determined comparison value; and
providing the base machine learning model that has been compressed as an output based on the compressed base machine learning model satisfying the predefined criteria.
